(19) United States
(12) Patent Application Publication
(10) Pub. No.: US 2025/0196629 A1
(43) Pub. Date: Jun. 19, 2025

(54) DRIVING APPARATUS FOR FOUR-WHEEL DRIVE ELECTRIC VEHICLE

(71) Applicants: Hyundai Motor Company, Seoul (KR); Kia Corporation, Seoul (KR)

(72) Inventors: Jongyun PARK, Hwaseong-Si (KR); Sangjin PARK, Hwaseong-si (KR); Sung Kyu KIM, Hwaseong-Si (KR); Chonok KIM, Hwaseong-Si (KR)

(73) Assignees: Hyundai Motor Company, Seoul (KR); Kia Corporation, Seoul (KR)

(21) Appl. No.: 18/970,460

(22) Filed: Dec. 5, 2024

(30) Foreign Application Priority Data
Dec. 13, 2023 (KR) 10-2023-0180624

(51) Int. Cl. B60K 17/348; B60K 1/02; B60K 17/02; B60K 17/06; B60K 17/16; B60K 17/356; B60K 23/08

(52) U.S. Cl. CPC B60K 17/348; B60K 17/02; B60K 17/06; B60K 17/165; B60K 17/356; B60K 23/08; B60K 1/02

(57) ABSTRACT

A driving apparatus for a four-wheel drive electric vehicle, torque output from a motor is reduced by a reducer and driving torque is transmitted to both wheels through a differential while compensating for the difference in rotation speed, the driving apparatus includes a first disconnector that transmits or blocks torque output from the reducer to the two wheels, and a second disconnector configured inside the reducer to selectively output or block the torque of the motor selectively shifted to two speeds by the reducer.

### CROSS-REFERENCE TO RELATED APPLICATION

The present application claims priority to Korean Patent Application No. 10-2023-0180624 filed on Dec. 13, 2023, the entire contents of which is incorporated herein for all purposes by this reference.

### BACKGROUND OF THE PRESENT DISCLOSURE

### Field of the Present Disclosure

The present disclosure relates to a driving apparatus for a four-wheel drive electric vehicle. More particularly, the present disclosure relates to a driving apparatus for a four-wheel drive electric vehicle that solves problems such as the engage impact and engage time of the dog clutch in low-speed and high-speed regions by adding a disconnector configured for two-stage change inside the reducer.

### Description of Related Art

Environment-friendly technology in the vehicle field is a core technology that will determine the survival of the future vehicle industry, and vehicle manufacturers are making all-out efforts to develop environment-friendly vehicles to achieve environmental and fuel efficiency regulations.

As part of these environment-friendly vehicles, vehicle manufacturers are focusing on the development of environment-friendly electric vehicles such as hybrid electric vehicles (HEVs), plug-in hybrid electric vehicles (PHEVs), pure electric vehicles (BEVs), and fuel cell electric vehicles (FCEVs).

Since environment-friendly vehicles have various technical limitations such as weight and cost, vehicle manufacturers are paying attention to electric vehicles as a realistic alternative to satisfy exhaust gas regulations and improve fuel efficiency performance, and are also competing fiercely in research and development of power delivery devices to put them into practice.

An environment-friendly vehicle utilizes a motor as a power source to provide torque, and a driving apparatus is applied that increases the torque through a reducer to provide driving torque to the vehicle. This can contribute to improve environmental pollution in large cities by reducing exhaust gas, the main culprit of air pollution caused by existing internal combustion engine vehicles.

The driving apparatus of a four-wheel drive (4WD) electric vehicle is applied to the front and rear wheels respectively, and a disconnector system is configured on the auxiliary driving wheel of one of the driving apparatuses of the front and rear wheels to enhance fuel efficiency. Through this, a technology is being applied to separate the vehicle body and driving apparatus (motor, reducer, etc.) when driving a two-wheel drive (2WD) to reduce the drag torque caused by the counter electromotive force of the motor and the drag torque of the reducer, improving the fuel efficiency.

These disconnector systems can generally be applied with a dog clutch, and there are differences in fuel economy (MPGe; Miles Per Gallon gasoline equivalent), engage impact, engage time, etc. depending on the mounting position of the disconnector system, which is usually mounted on the auxiliary drive wheel.

In the case of the recently developed disconnector system, the focus is on optimizing power efficiency by positioning it on the differential side or on the driveshaft. However, in the low-speed section (0-20 kph) and high-speed section (over 120 kph), the dog clutch teeth are of a flat-chamfer type with a flat contacting surface, so there is a high possibility that the teeth of the dog clutch will not mesh smoothly, which may cause a baulking phenomenon depending on the operating situation. Since the relative rotation between the dog clutches must be adjusted through the torque control of the motor to engage the dog clutch, problems such as engage impact or engage time may occur.

Accordingly, recently, the engage impact problem in the low-speed section and the engage time problem in the high-speed section are being solved by engaging the dog clutch in the low-speed section (0-20 kph) and high-speed section (over 120 kph) to drive as a four-wheel drive (4WD).

However, the problem of lower fuel efficiency (MPGe) when driving with four-wheel drive (4WD) in low-speed sections (0-20 kph) and high-speed sections (over 120 kph) compared to driving with two-wheel drive (2WD) still persists.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a driving apparatus for a four-wheel drive electric vehicle that solves problems such as engage impact and engage time of a dog clutch in low-speed and high-speed regions by adding a disconnector configured for two-stage speed change inside a reducer.

Furthermore, an exemplary embodiment attempts to provide a driving apparatus for a four-wheel drive electric vehicle that can improve fuel efficiency (MPGe) compared to a four-wheel drive (4WD) by enabling driving by two-wheel drive (2WD) and further expand the region of a high-speed section by two-wheel drive (2WD).

Furthermore, an exemplary embodiment attempts to provide a driving apparatus for a four-wheel drive electric vehicle that enables reduction of motor torque by increasing the gear ratio at first speed through the addition of a disconnector configured for two-speed change inside the reducer, reducing the weight and cost of the motor.

A driving apparatus for a four-wheel drive electric vehicle, torque output from a motor is reduced by a reducer and driving torque is transmitted to both wheels through a differential while compensating for the difference in rotation speed, the driving apparatus according to exemplary disclosures may include a first disconnector that transmits or blocks torque output from the reducer to the two wheels, and a second disconnector configured inside the reducer to selectively output or block the torque of the motor selectively shifted to two speeds by the reducer.

The first disconnector may include a dog clutch configured between a differential ring gear and a differential case of the differential.

The reducer may include an input shaft into which the torque of the motor is input, first and second input gears each mounted on the input shaft, an output shaft disposed parallel to the input shaft and the differential, and including an output gear provided on one side thereof which is engaged with a differential ring gear of the differential, and first and second shifting gears which are rotatably disposed on the output shaft and engaged with the first and second input gears respectively, and selectively connectable to the output shaft by the second disconnector.

The second disconnector may include a dog clutch provided on the output shaft to be axially movable and selectively connect the first shifting gear or the second shifting gear to the output shaft.

In a four-wheel drive, the first disconnector may be engaged and connected to transmit the torque of the motor to both wheels at all times, and the second disconnector may be simultaneously engaged to either the first shifting gear or the second shifting gear of the reducer to transmit the torque of the motor, which has been shifted to 1st or 2nd speed, to the output shaft.

In a two-wheel drive, in section 1 driving including a predetermined low-speed section and a predetermined high-speed section, the first disconnector may be engaged and simultaneously the second disconnector may be controlled to neutral so that the power delivery path is blocked inside the reducer.

In a two-wheel drive, in section 2 driving including a predetermined medium-speed section, the first disconnector may be released to block the power delivery path to the driveshaft, and the second disconnector may be configured to engage either the first shifting gear or the second shifting gear of the reducer at the same time.

The first disconnector may include a dog clutch configured on one of the driveshafts that transmits torque from the differential to both wheels.

The first disconnector may include an internal case connected to first and second end portions of a pinion shaft inside a differential case of the differential and rotatably provided with pinion gears on first and second sides thereof, and including first engage teeth formed on one side, and a dog clutch including second engaging teeth formed to be configured for engaging the first engaging teeth and disposed to be movable in the axial direction through a sleeve spline-joined to an external side of the differential case.

The driving apparatus may be configured on an auxiliary driving wheel side among a front wheel side apparatus and a rear wheel side driving apparatus.

A driving apparatus for a four-wheel drive electric vehicle, the driving apparatus according to exemplary disclosures may include a motor configured on an auxiliary drive wheel side to output torque, a reducer that selectively changes the torque of the motor transmitted through an input shaft into two speeds and outputs the changed speed to an output shaft, a differential configured between the output shaft and driveshafts on both sides which transmit driving torque to the wheels on both sides, and transmits the torque output from the output shaft to the wheels on both sides while compensating for the difference in rotation speed, a first disconnector that transmits or blocks the torque output from the reducer to the two wheels, and a second disconnector configured inside the reducer to selectively transmit or block the torque of the motor to the output shaft.

The first disconnector may include a dog clutch configured between a differential ring gear and a differential case of the differential.

The reducer may include an input shaft into which the torque of the motor is input, first and second input gears each mounted on the input shaft, an output shaft disposed parallel to the input shaft and the differential, and including an output gear provided on one side thereof which is engaged with a differential ring gear of the differential, and first and second shifting gears which are rotatably disposed on the output shaft and engaged with the first and second input gears respectively, and selectively connectable to the output shaft by the second disconnector.

The second disconnector may include a dog clutch provided on the output shaft to be axially movable and selectively connect the first shifting gear or the second shifting gear to the output shaft.

In a four-wheel drive, the first disconnector may be engaged and connected to transmit the torque of the motor to both wheels at all times, and the second disconnector may be simultaneously engaged to either the first shifting gear or the second shifting gear of the reducer to transmit the torque of the motor, which has been shifted to 1st or 2nd speed, to the output shaft.

In a two-wheel drive, in section 1 driving including a predetermined low-speed section and a predetermined high-speed section, the first disconnector may be engaged and simultaneously the second disconnector may be controlled to neutral so that the power delivery path is blocked inside the reducer.

In a two-wheel drive, in section 2 driving including a predetermined medium-speed section, the first disconnector may be released to block the power delivery path to the driveshaft, and the second disconnector may be configured to engage either the first shifting gear or the second shifting gear of the reducer at the same time.

The first disconnector may include a dog clutch configured on one of the driveshafts that transmits torque from the differential to both wheels.

The first disconnector may include an internal case connected to first and second end portions of a pinion shaft inside a differential case of the differential and rotatably provided with pinion gears on first and second sides thereof, and including first engage teeth formed on one side, and a dog clutch including second engaging teeth formed to be configured for engaging the first engaging teeth and disposed to be movable in the axial direction through a sleeve spline-joined to an external side of the differential case.

According to the driving apparatus for a four-wheel drive electric vehicle, by adding a disconnector configured for two-stage speed change inside a reducer, may solve problems such as engage impact and engage time of a dog clutch in low-speed and high-speed regions. Furthermore, according to the driving apparatus for a four-wheel drive electric vehicle, it is possible to improve fuel economy (MPGe) compared to four-wheel drive (4WD) by enabling driving with two-wheel drive (2WD), and to further expand the high-speed section area with two-wheel drive (2WD).

According to the driving apparatus for a four-wheel drive electric vehicle, by adding a second disconnector configured for two-speed change inside the reducer, it is possible to reduce the motor torque by increasing the gear ratio in 1st speed, reducing the weight and cost of the motor.

Furthermore, the effects which may be obtained or expected due to various exemplary embodiments of the present disclosure are directly or implicitly included in the detailed description of the present disclosure. That is, various effects predicted according to exemplary embodiments of the present disclosure will be included in the detailed description to be provided later.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a drawing showing a vehicle body to which a driving apparatus for a four-wheel drive electric vehicle according to an exemplary embodiment of the present disclosure may be applied.

FIG. 2 is a schematic diagram of an auxiliary drive wheel side driving apparatus of a four-wheel drive electric vehicle according to a first exemplary embodiment of the present disclosure.

FIG. 3 is an operation table of the driving method of the auxiliary driving wheel side driving apparatus of a four-wheel drive electric vehicle according to the first exemplary embodiment of the present disclosure.

FIG. 4, FIG. 5, FIG. 6 and FIG. 7 are operation state diagrams the auxiliary driving wheel side driving apparatus of a four-wheel drive electric vehicle according to the first exemplary embodiment of the present disclosure.

FIG. 8 is a schematic diagram of an auxiliary drive wheel side driving apparatus of a four-wheel drive electric vehicle according to a second exemplary embodiment of the present disclosure.

FIG. 9 is a schematic diagram of a differential and a first disconnector applied to an auxiliary drive wheel side driving apparatus on a four-wheel drive electric vehicle according to an exemplary variation of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments included in the present specification will be described in detail with reference to the appended drawings. The same or similar components are provided the same or similar drawing reference numerals, and redundant descriptions thereof are omitted.

In describing the exemplary embodiments included in the present specification, if it is determined that a detailed description of a related known technology may obscure the gist of the exemplary embodiments included in the present specification, the detailed description is omitted. Furthermore, the appended drawings are only intended to facilitate easy understanding of the exemplary embodiments included in the present specification, and the technical ideas included in the present specification are not limited by the appended drawings, but should be understood to include all modifications, equivalents, or substitutes included in the spirit and technical scope of the present disclosure.

Terms including ordinal numbers, such as first, second, etc., may be used to describe various components, but the components are not limited by the terms. The above terms are used solely to distinguish one component from another.

When a component is said to be “connected” or “combined” to another component, it should be understood that it may be directly connected or combined to that other component, but there may also be other components in between. On the other hand, when a component is said to be “directly connected” or “directly combined” to another component, it should be understood that there are no other components in between.

In the present application, terms such as “include” or “have” should be understood to specify the presence of a feature, number, step, operation, component, part or combination thereof described in the specification, but not to exclude in advance the possibility of the presence or addition of one or more other features, numbers, steps, operations, components, parts or combinations thereof.

Terms such as “-unit”, “-portion”, “-part”, “-module”, and “-means” described in the specification are assigned or used interchangeably only for the convenience of writing the specification, and do not have distinct meanings or roles in themselves. Additionally, terms such as “-unit”, “-portion”, “-part”, “-module”, and “-means” described in the specification may mean a unit that processes at least one function or operation, which may be implemented by hardware, software, or a combination of hardware and software.

As used herein, the singular forms are intended to include the plural forms as well, unless the context clearly indicates otherwise. As used herein, the term “and/or” includes any one or all combinations of the associated listed items.

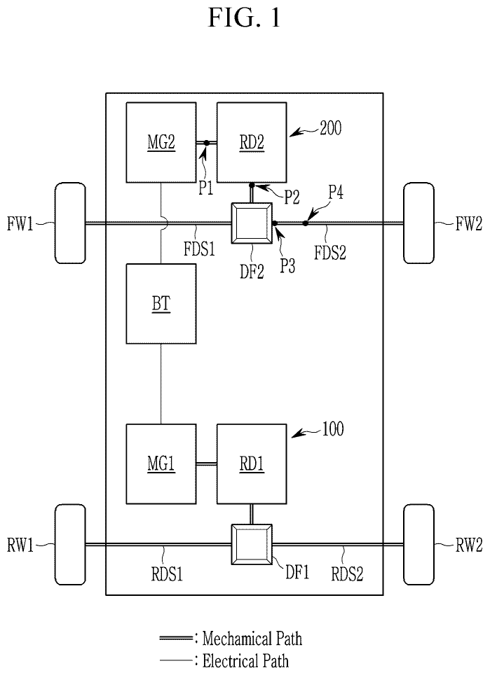

FIG. 1 is a drawing showing a vehicle body to which a driving apparatus for a four-wheel drive electric vehicle according to an exemplary embodiment of the present disclosure may be applied.

Referring to FIG. 1, a vehicle to which a driving apparatus for a four-wheel drive electric vehicle according to an exemplary embodiment of the present disclosure may be applied includes a rear wheel-side driving apparatus 100 including a first motor MG1, a first reducer RD1, and a first differential DF1 and transmitting power to left and right rear wheels RW1 and RW2 through left and right rear wheel driveshafts RDS1 and RDS2, a front wheel-side driving apparatus 200 including a second motor MG2, a second reducer RD2, and a second differential DF2 and transmitting power to left and right front wheels FW1 and FW2 through left and right front wheel driveshafts FDS1 and FDS2, and a battery BT supplying power to the first and second motors MG1 and MG2.

The first, second motor MG1, and MG2 generate output torque by controlling the rotation direction and rotation speed revolutions per minute (rpm) by Motor Control Unit (MCU). The first motor MG1 provides power to the left and right rear wheels RW1 and RW2, and the second motor MG2 provides power to the left and right front wheels FW1 and FW2.

These first and second motors MG1 and MG2 may be used as generators to charge the battery BT by generating counter electromotive force when the battery's state of charge (SOC) is low or during regenerative braking.

The first and second reducers RD1 and RD2 are a type of transmission that reduces and transmits the power generated from the first and second motors MG1 and MG2 to the corresponding wheels RW1, RW2, FW1, and FW2, respectively. The first reducer RD1 controls the rotation speed (motor torque) of the first motor MG1 and transmits it to the left and right rear wheels RW1 and RW2, and the second reducer RD2 controls the rotation speed of the second motor MG2 and transmits it to the left and right front wheels FW1 and FW2.

The first and second differentials DF1 and DF2 are connected to the output end portions of the first and second reducers RD1 and RD2, respectively, and transmit the output torque of the first and second reducers RD1 and RD2 to the corresponding wheels RW1, RW2, FW1, and FW2. The first reducer RD1 transmits the power generated from the first motor MG1 while compensating for the difference in rotation speed between the left and right rear wheels RW1 and RW2, and the second reducer RD2 transmits the power generated from the second motor MG2 while compensating for the difference in rotation speed between the left and right front wheels FW1 and FW2.

The driving apparatus of a four-wheel drive electric vehicle including the present configuration operates either the front wheel side or the rear wheel side as an auxiliary driving wheel, and in the case of four-wheel drive (4WD), both the front wheel side driving apparatus and the rear wheel side driving apparatus are driven to transmit power to both the front and rear wheels. Additionally, in the case of two-wheel drive (2WD), the power of the driving apparatus on the main driving wheel side is transmitted to the corresponding wheel, and the power of the driving apparatus on the auxiliary driving wheel side is disconnected.

Assuming that the auxiliary driving wheel side driving apparatus of a four-wheel drive electric vehicle is the front wheel side driving apparatus 200, a disconnector may be provided in the front wheel side driving apparatus 200 to cut off the power of the second motor MG2 at the left and right front wheels FW1 and FW2.

The disconnector may be provided at Pl on one side of the input shaft to which power of the second motor MG2 is directly transmitted, or at P2 on one side of the second reducer RD2, or at P3 on one side of the second differential DF2, or at P4 on one side of the front wheel driveshaft FDS1 or FDS2.

The disconnector may be provided at one of the four locations P1, P2, P3, and P4 of the driving apparatus 200 on the front wheel side of the auxiliary driving wheel, and there are differences in fuel efficiency (MPGe), engage impact, engage time, etc. depending on the installation location.

That is, in terms of install position, there are no issues such as engage impact or engage time at P1 and P2 positions, but it is disadvantageous in terms of power efficiency (MPGe), and conversely, in terms of P3 and P4 positions, it is advantageous in terms of power efficiency (MPGe), but issues such as engage impact or engage time may occur.

According to an exemplary embodiment of the present disclosure, a driving apparatus for a wheel drive electric vehicle may include a disconnector provided on one side P3 of a second differential DF2 of a driving apparatus 200 on the front wheel side, with the auxiliary driving wheel on the front wheel side. Additionally, when the auxiliary driving wheel is on the rear wheel side, a disconnector may be provided on one side of the first differential DF1 of the driving apparatus 100 on the rear wheel side.

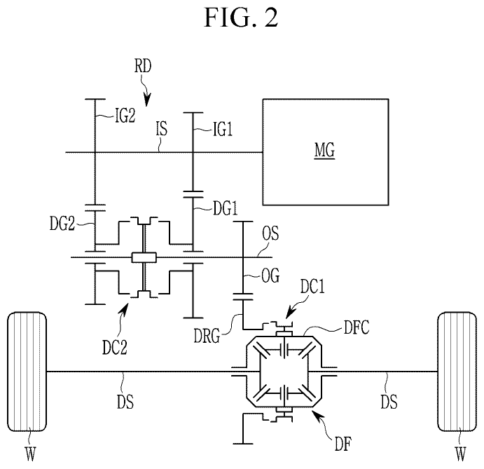

FIG. 2 is a schematic diagram of an auxiliary drive wheel side driving apparatus of a four-wheel drive electric vehicle according to a first exemplary embodiment of the present disclosure.

Referring to FIG. 2, the driving apparatus for a four-wheel drive electric vehicle (hereinafter, referred to as the driving apparatus) according to the first exemplary embodiment of the present disclosure is described including examples of including the auxiliary driving wheel on the front wheel side or the rear wheel side, and the names and reference numerals of some components are expressed as motor MG, two-stage reducer RD, differential DF, driveshaft DS, and wheel W.

That is, the driving apparatus according to the first exemplary embodiment of the present disclosure may be provided as the driving apparatus of the rear wheel, which is an auxiliary driving wheel, in the case of an electric vehicle with the front wheel side as the main driving wheel, and may be provided as the driving apparatus of the front wheel, which is an auxiliary driving wheel, in the case of an electric vehicle with the rear wheel side as the main driving wheel.

The driving apparatus may include a motor MG, a reducer RD, a differential DF, first and second disconnectors DC1, and DC2.

The motor MG is configured on an input shaft IS of the auxiliary driving wheel and directly outputs torque to the input shaft IS.

The reducer RD is configured to selectively change the torque of the motor MG transmitted through the input shaft IS into two speeds and output it to an output shaft OS.

That is, reducer RD includes the input shaft IS, first and second input gears IG1, and IG2, the output shaft OS, first and second shifting gears DG1, and DG2.

The input shaft IS is directly connected to an output shaft of the motor MG, so that the torque of the motor MG is input as is.

The first, second input gears IG1, and IG2 are each provided on the input shaft IS and rotate together with the input shaft IS.

The output shaft OS is disposed parallel between the input shaft IS and the differential DF, and an output gear OG is provided on one side of the output shaft OS. The output gear OG is externally engaged with a differential ring gear DRG of the differential DF and transmits the torque of the output shaft OS to the differential DF.

The first, second shifting gears DG1 and DG2 are rotatably disposed on the output shaft OS and externally engaged with first and second input gears IG1 and IG2, respectively, and are provided to be selectively connectable to the output shaft OS by the second disconnector DC2.

That is, the torque of motor MG transmitted to input shaft IS is transmitted to the output shaft OS by being shifted (decelerated) to first speed through the first input gear IG1 and the first shifting gear DGI when the first shifting gear DGI is connected to the output shaft OS by operation of the second disconnector DC2. When the second shifting gear DG2 is connected to the output shaft OS by operation of the second disconnector DC2, the torque of the motor MG is shifted to second speed and transmitted to the output shaft OS through the second input gear IG2 and the second shifting gear DG2.

The differential DF is configured between the output shaft OS and the driveshafts DS on both sides that transmit driving torque to the wheels W on both sides, and is configured to transmit the torque output from the output shaft OS to the wheels W on both sides while compensating for the difference in rotation speed.

That is, the differential DF transmits the torque output to the output shaft OS through the driveshafts DS on both sides to the wheels W on both sides by externally engaging the differential ring gear DRG connected to the differential case DFC with the output gear OG on the output shaft OS. The differential DF is configured to perform a differential function while compensating for the difference in rotation speed between the two wheels W.

The first disconnector DC1 is configured between the differential DF and one wheel W and is configured to transmit or block the torque output from the reducer RD to both wheels W.

That is, the first disconnector DC1 may include a dog clutch configured between the differential ring gear DRG of the differential DF and the differential case DFC.

The first disconnector DC1 may be applied with a dog clutch including a flat chamfer type tooth shape with a flat tooth contacting surface considering power delivery efficiency.

Additionally, the second disconnector DC2 is configured inside the reducer RD to selectively transmit or block the torque of the shifted motor MG to the output shaft OS.

This second disconnector DC2 includes a dog clutch provided axially movable on the output shaft OS and is configured to selectively connect the first shifting gear DG1 or the second shifting gear DG2 to the output shaft OS.

The second disconnector DC2 may be applied with a dog clutch including a chamfer type tooth profile with a sharp-pointed tooth contacting surface considering the engage function for gear shifting.

Hereinafter, the operation of the driving apparatus for a four-wheel drive electric vehicle according to the first exemplary embodiment of the present disclosure is described by driving method.

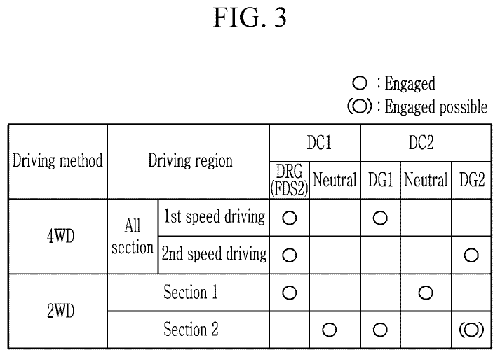

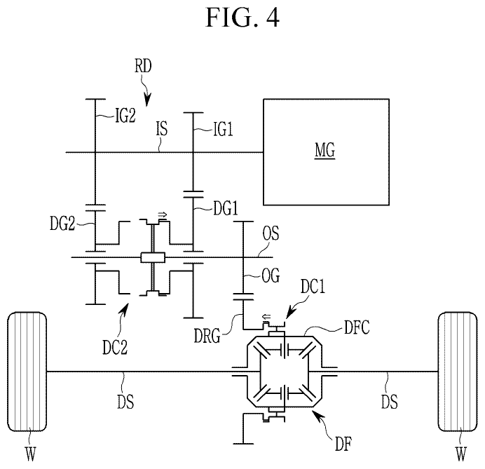

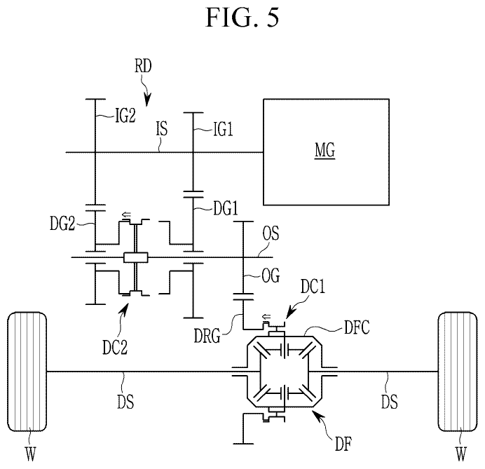

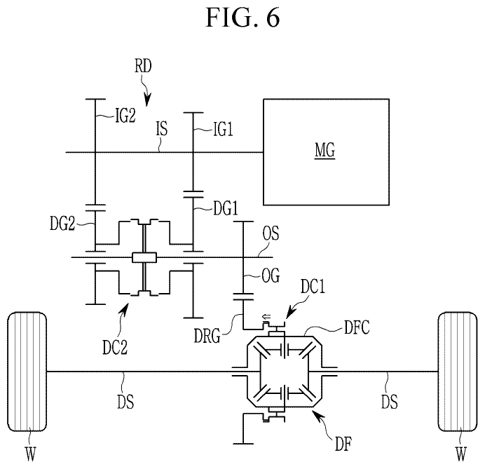

FIG. 3 is an operation table of the driving method of the auxiliary driving wheel side driving apparatus of a four-wheel drive electric vehicle according to the first exemplary embodiment of the present disclosure. FIG. 4, FIG. 5, FIG. 6 and FIG. 7 are operation state diagrams the auxiliary driving wheel side driving apparatus of a four-wheel drive electric vehicle according to the first exemplary embodiment of the present disclosure.

The driving apparatus according to the exemplary embodiments of the present disclosure is applied and operated on the auxiliary driving wheel side of a four-wheel drive electric vehicle, and may be divided into four-wheel drive (4WD) and two-wheel drive (2WD) depending on the driving method.

Additionally, if the entire section includes low-speed, medium-speed, and high-speed sections based on vehicle speed, the low-speed section may be set as a section between 0 and 20 kph, the medium-speed section may be set as a section between 20 and 120 kph, and the high-speed section may be set as a section over 120 kph. For the convenience of understanding, low-speed sections, medium-speed sections, and high-speed sections are set as above, but it is not limited to this, and various vehicle speeds may be set depending on the type of vehicle to which it is applied.

In FIG. 3, section 1 is defined as a driving region of a predetermined low-speed section and a predetermined high-speed section, and section 2 is defined as a driving region of a predetermined medium-speed section.

The driving apparatus according to the first exemplary embodiment of the present disclosure is an auxiliary driving wheel side driving apparatus, in which the torque of the motor MG is transmitted to the wheel W side only in the case of four-wheel drive (4WD), and in the case of two-wheel drive (2WD), the power delivery path between the motor MG and the wheel W is blocked to prevent them from being connected.

### 1st Speed Driving of Four-Wheel Drive (4WD)

Referring to FIG. 3 and FIG. 4, in the case of 1st speed driving of four-wheel drive (4WD) the first disconnector DC1 is engaged to connect the differential case DFC and the differential ring gear DRG, and simultaneously the second disconnector DC2 is engaged with the first shifting gear DGI of the reducer RD.

Accordingly, the torque of motor MG is transmitted to the differential DF by being shifted to 1st speed through the input shaft IS, the first input gear IG1, the first shifting gear DG1, the output shaft OS, the output gear OG, and the differential ring gear DRG.

Accordingly, the torque of the motor MG is shifted to 1st speed in the reducer RD and transmitted to the differential DF while compensating for the difference in rotation speed between the wheels W on both sides, enabling the electric vehicle to run in 1st speed in four-wheel drive (4WD).

### 2nd Speed Driving of Four-Wheel Drive (4WD)

Referring to FIG. 3 and FIG. 5, in the case of 2nd speed driving of four-wheel drive (4WD), the first disconnector DC1 is engaged to connect the differential case DFC and the differential ring gear DRG, and simultaneously the second disconnector DC2 is engaged with the second shifting gear DG2 of the reducer RD.

Accordingly, the torque of the motor MG is transmitted to the differential DF through the input shaft IS, the second input gear IG2, the second shifting gear DG2, the output shaft OS, the output gear OG, and the differential ring gear DRG in two-speed shifting.

Accordingly, the torque of the motor MG is transmitted to the differential DF while being shifted to the second gear in the reducer RD and compensating for the difference in rotation speed between the wheels W on both sides, enabling the electric vehicle to run in 2nd speed driving of four-wheel drive (4WD).

In the present way, the four-wheel drive (4WD) according to the driving apparatus according to the first exemplary embodiment of the present disclosure may be implemented in all sections with the vehicle speed as a reference, and can increase energy efficiency such as fuel efficiency (MPGe) by providing two speed shifting including the 1st and 2nd speeds.

Meanwhile, the driving apparatus according to the first exemplary embodiment are an auxiliary driving wheel side driving apparatus, and in two-wheel drive (2WD), the power delivery path between the motor MG and the wheel W is blocked, so that the power is not connected. However, to block the present power, one of the first and second disconnectors DC1 and DC2 is released.

### Section 1 Driving of 2WD (Two-Wheel Drive)

Referring to FIG. 3 and FIG. 6, in the section 1 of a two-wheel drive (2WD) (i.e., low-speed section between 0 and 20 kph and high-speed section above 120 kph), the first disconnector DC1 is engaged to connect the differential case DFC and the differential ring gear DRG, and simultaneously the second disconnector DC2 is controlled to the neutral position to block the power delivery path inside the reducer RD.

At the present time, the motor MG is controlled in a stationary state, and the electric vehicle is configured for section 1 driving of two-wheel drive (2WD).

### Section 2 Driving of 2WD (Two-Wheel Drive)

Referring to FIG. 3 and FIG. 7, in section 2 driving of the two-wheel drive (2WD) (i.e., the medium-speed range of 20 kph to 120 kph), the first disconnector DC1 is released to neutral, blocking the power delivery path to the driveshaft DS, and simultaneously the second disconnector DC2 engages the first shifting gear DG1 of the reducer RD.

At the present time, the motor MG is controlled in a stationary state, and the electric vehicle is configured for section 2 driving of two-wheel drive (2WD).

Here, the second disconnector DC2 can engage one of the first shifting gear or the second shifting gears of the reducer RD depending on driving conditions such as vehicle speed to prepare for four-wheel drive (4WD).

Referring to FIG. 1 and FIG. 2, the driving apparatus according to the first exemplary embodiment of the present disclosure is applied as a driving apparatus of an auxiliary driving wheel, and in a low-speed section of 0 to 20 kph and a high-speed section of 120 kph or more, the second disconnector DC2 configured in one side P2 of the second reducer RD2 is released to neutral to enable two-wheel drive (2WD) of the electric vehicle.

In the low-speed section of 0-20 kph vehicle speed region, the first disconnector DC1 is pre-engaged, so that control such as motor torque coordination control is unnecessary, removing the cause of the engage impact. Furthermore, in the high-speed section of 120 kph or more vehicle speed region, the cause of the baulking phenomenon of the first disconnector DC1 is removed, resolving problems such as the engage time.

Additionally, the driving region on the high-speed section may be expanded with two-wheel drive (2WD), which includes an effect of improving fuel economy (MPGe) on actual roads.

Meanwhile, in the medium-speed section between 20 kph and 120 kph, the first disconnector DC1 configured on one side P3 of the second differential DF2 is released as before to enable two-wheel drive (2WD) of the electric vehicle.

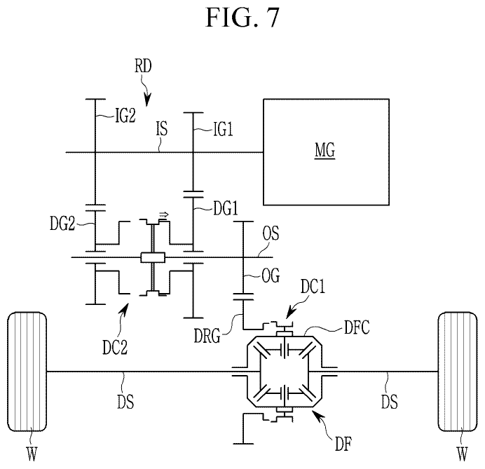

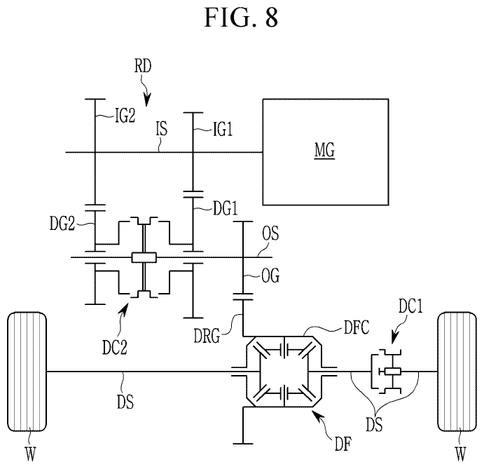

FIG. 8 is a schematic diagram of an auxiliary drive wheel side driving apparatus of a four-wheel drive electric vehicle according to a second exemplary embodiment of the present disclosure.

For convenience of understanding, when describing the auxiliary driving wheel side driving apparatus of a four-wheel drive electric vehicle according to the second exemplary embodiment of the present disclosure, the same components as those of the auxiliary driving wheel side driving apparatus of the four-wheel drive electric vehicle according to the first exemplary embodiment of the present disclosure will be provided the same reference numerals.

Referring to FIG. 8, in the driving apparatus for a four-wheel drive electric vehicle according to a second exemplary embodiment of the present disclosure, there is a difference in the installation location of the first disconnector DC1 compared to the first exemplary embodiment of the present disclosure.

That is, the first disconnector DC1 according to the first exemplary embodiment of the present disclosure is configured between the differential ring gear DRG of the differential DF and the differential case DFC, but in the second exemplary embodiment of the present disclosure, the first disconnector DC1 may include a dog clutch configured on one of the driveshaft DS among the two driveshafts DS that transmit torque from the differential DF to the two wheels W.

Thus, the second exemplary embodiment of the present disclosure is different from the first exemplary embodiment only in the installation location of the first disconnector DC1 applied, and the other configurations, operations and effects are the same, and is not described in further detail.

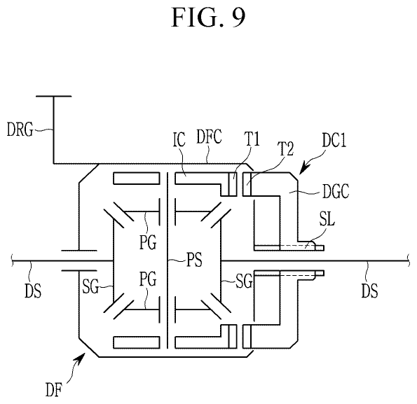

FIG. 9 is a schematic diagram of a differential and a first disconnector applied to an auxiliary drive wheel side driving apparatus on a four-wheel drive electric vehicle according to an exemplary variation of the present disclosure.

For convenience of understanding, when explaining an auxiliary driving wheel side driving apparatus of a four-wheel drive electric vehicle according to a variation of the first exemplary embodiment of the present disclosure, the same components as those of the auxiliary driving wheel side driving apparatus of the four-wheel drive electric vehicle according to the first exemplary embodiment of the present disclosure described above will be provided the same reference numerals.

Referring to FIG. 9, an exemplary variation of a first disconnector DC1 is presented in a driving apparatus for a four-wheel drive electric vehicle according to an exemplary variation of the present disclosure.

The first disconnector DC1 according to the first exemplary embodiment of the present disclosure is configured between the differential ring gear DRG of the differential DF and the differential case DFC, as an example.

The first disconnector DC1 according to the exemplary variation includes an internal case IC connected to both end portions of a pinion shaft PS inside the differential case DFC of the differential DF. The internal case IC has first engage teeth T1 formed on one side and is rotatably provided with pinion gears PG on both sides.

The differential ring gear DRG and the differential case DFC are connected, and the side gears SG on both sides connected to the driveshaft DS are engaged with the pinion gears PG on both sides.

Additionally, the first disconnector DC1 may include a dog clutch DGC including a sleeve SL spline-coupled to one external side of the differential case DFC. The dog clutch DGC includes second engaging teeth T2 formed to engage the first engaging teeth T1.

With the differential case DFC and internal case IC separated, the rotation of the differential ring gear DRG is not transmitted to the driveshaft DS. That is, when the first engage teeth Tl of the internal case IC and the second engage teeth T2 of the dog clutch DGC are separated, the torque of the differential case DFC is not transmitted to the internal case IC.

When the internal case IC is connected to the differential case DFC by the dog clutch DGC, that is, when the dog clutch DGC moves and the second engage teeth T2 of the dog clutch DGC engage the first engage teeth T1 of the internal case IC, the torque of the differential case DFC is transmitted to the internal case IC, causing the internal case IC to rotate.

The pinion gears PG on both sides of the pinion shaft PS also rotate together with the internal case IC, and the torque of the motor MG is transmitted to the driveshaft DS along with the differential function of the pinion gears PG on both sides of the pinion shaft PS and the side gears SG on both sides.

Thus, the differential DF and the first disconnector DC1 according to one example and another example applied to the first exemplary embodiment of the present disclosure have some differences in some configurations and operation methods, but their basic functions and effects are the same, and are not described in further detail.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A driving apparatus for a four-wheel drive electric vehicle, in which torque output from a motor is reduced by a reducer and driving torque is transmitted to first and second wheels through a differential while compensating for a difference in rotation speed, the driving apparatus comprising:
a first disconnector that transmits or blocks torque output from the reducer to the first and second wheels; and
a second disconnector configured inside the reducer to selectively output or block the torque of the motor selectively shifted to two speeds by the reducer.

2. The driving apparatus of claim 1, wherein the first disconnector includes a dog clutch configured between a differential ring gear and a differential case of the differential.

3. The driving apparatus of claim 1, wherein the reducer includes:
an input shaft into which the torque of the motor is input;
first and second input gears each mounted on the input shaft;
an output shaft disposed parallel to the input shaft and the differential, and including an output gear mounted on one side of the output shaft which is engaged with a differential ring gear of the differential; and
first and second shifting gears which are rotatably disposed on the output shaft and engaged with the first and second input gears respectively, and selectively connectable to the output shaft by the second disconnector.

4. The driving apparatus of claim 3, wherein the second disconnector includes a dog clutch provided on the output shaft to be axially movable and selectively connect the first shifting gear or the second shifting gear to the output shaft.

5. The driving apparatus of claim 3, wherein in a four-wheel drive, the first disconnector is engaged and connected to transmit the torque of the motor to the first and second wheels at all times, and the second disconnector is simultaneously engaged to either the first shifting gear or the second shifting gear of the reducer to transmit the torque of the motor, which has been shifted to 1st or 2nd speed, to the output shaft.

6. The driving apparatus of claim 3, wherein in a two-wheel drive, in section 1 driving including a predetermined low-speed section and a predetermined high-speed section, the first disconnector is engaged and simultaneously the second disconnector is controlled to neutral so that a power delivery path is blocked inside the reducer.

7. The driving apparatus of claim 3, wherein in a two-wheel drive, in section 2 driving including a predetermined medium-speed section, the first disconnector is released to block a power delivery path to driveshafts connected to the first and second wheels, and the second disconnector is configured to engage either the first shifting gear or the second shifting gear of the reducer at the same time.

8. The driving apparatus of claim 1, wherein the first disconnector includes a dog clutch configured on one of driveshafts that transmits torque from the differential to the first and second wheels.

9. The driving apparatus of claim 1, wherein the first disconnector includes:
an internal case connected to first and second end portions of a pinion shaft inside a differential case of the differential and rotatably provided with pinion gears on first and second sides thereof, and including first engage teeth formed on one side; and
a dog clutch including second engaging teeth formed to be configured for engaging the first engaging teeth and disposed to be movable in an axial direction through a sleeve spline-joined to an external side of the differential case.

10. The driving apparatus of claim 1, wherein the driving apparatus is configured on an auxiliary driving wheel side among a front wheel side apparatus and a rear wheel side driving apparatus.

11. A driving apparatus for a four-wheel drive electric vehicle, the driving apparatus comprising:
a motor configured on an auxiliary drive wheel side to output torque;
a reducer that selectively changes the torque of the motor transmitted through an input shaft into two speeds and outputs a changed speed to an output shaft;
a differential configured between the output shaft and driveshafts on first and second sides which transmit driving torque to first and second wheels on the first and second sides, and transmits a torque output from the output shaft to the first and second wheels while compensating for a difference in rotation speed;
a first disconnector that transmits or blocks the torque output from the reducer to the first and second wheels; and
a second disconnector configured inside the reducer to selectively transmit or block the torque of the motor to the output shaft.

12. The driving apparatus of claim 11, wherein the first disconnector includes a dog clutch configured between a differential ring gear and a differential case of the differential.

13. The driving apparatus of claim 11, wherein the reducer includes:
an input shaft into which the torque of the motor is input;
first and second input gears each mounted on the input shaft;
an output shaft disposed parallel to the input shaft and the differential, and including an output gear provided on one side thereof which is engaged with a differential ring gear of the differential; and
first and second shifting gears which are rotatably disposed on the output shaft and engaged with the first and second input gears respectively, and selectively connectable to the output shaft by the second disconnector.

14. The driving apparatus of claim 13, wherein the second disconnector includes a dog clutch provided on the output shaft to be axially movable and selectively connect the first shifting gear or the second shifting gear to the output shaft.

15. The driving apparatus of claim 13, wherein in a four-wheel drive, the first disconnector is engaged and connected to transmit the torque of the motor to the first and second wheels at all times, and the second disconnector is simultaneously engaged to either the first shifting gear or the second shifting gear of the reducer to transmit the torque of the motor, which has been shifted to 1st or 2nd speed, to the output shaft.

16. The driving apparatus of claim 13, wherein in a two-wheel drive, in section 1 driving including a predetermined low-speed section and a predetermined high-speed section, the first disconnector is engaged and simultaneously the second disconnector is controlled to neutral so that a power delivery path is blocked inside the reducer.

17. The driving apparatus of claim 13, wherein in a two-wheel drive, in section 2 driving including a predetermined medium-speed section, the first disconnector is released to block a power delivery path to the driveshafts, and the second disconnector is configured to engage either the first shifting gear or the second shifting gear of the reducer at the same time.

18. The driving apparatus of claim 11, wherein the first disconnector includes a dog clutch configured on one of the driveshafts that transmits torque from the differential to the first and second wheels.

19. The driving apparatus of claim 11, wherein the first disconnector includes:
an internal case connected to first and second end portions of a pinion shaft inside a differential case of the differential and rotatably provided with pinion gears on first and second sides thereof, and including first engage teeth formed on one side; and
a dog clutch including second engaging teeth formed to be configured for engaging the first engaging teeth and disposed to be movable in an axial direction through a sleeve spline-joined to an external side of the differential case.
